(19) United States
(12) Patent Application Publication
(10) Pub. No.: US 2017/0156290 A1
(43) Pub. Date: Jun. 8, 2017

(54) WEIGHTED ANIMAL VEST

(71) Applicant: Eul Eusan Speed, Fort Worth, TX (US)

(72) Inventor: Eul Eusan Speed, Fort Worth, TX (US)

(73) Assignee: Eul Eusan Speed, Fort Worth, TX (US)

(21) Appl. No.: 14/957,770

(22) Filed: Dec. 3, 2015

(51) Int. Cl. A01K 13/00; A01K 15/02

(52) U.S. Cl. CPC A01K 13/006; A01K 15/02

(57) ABSTRACT

The invention provides an improved full body vest than the normal harness type of product for dogs. The vest includes several pockets that hold weights distributed evenly on each leg of any four legged animal. There are four to six pockets varying on the size of the vest, and each pocket is designed to hold two weights depending on the size the individual wants to use. The weights can be adjusted taken in and out of each pocket, the four pockets holds eight weights or objects and the six pockets holds twelve weights or objects. The pockets are also designed to carry many other objects and also can be left empty and just worn as a vest to protect the animal's coat.

The Weighted Animal Vest is a uniquely designed weight vest for dogs. The Weighted Animal Vest fits on your pet like a saddle that holds and straps down to the chest area with two straps and one big strap across the belly allowing weights to be distributed evenly on all four legs creating balanced weights all over your pet's body. The Weighted Animal Vest is the same concept as a human weight vest for working out. Working out with added weights to a workout program will strengthen your body tremendously. Adding weights to a dog or an animal's everyday walking will allow your dog or animal to be much healthier and stronger as your pet ages, because many animals suffer from muscle and joint issues as they get older the Weighted Animal Vest supplies a way to keep your pets and animals in healthy conditions. The Weighted Animal Vest is not just for dogs it is for any and all four legged animal.

I has invented a new product called the WEIGHTED ANIMAL VEST as set forth in the following:

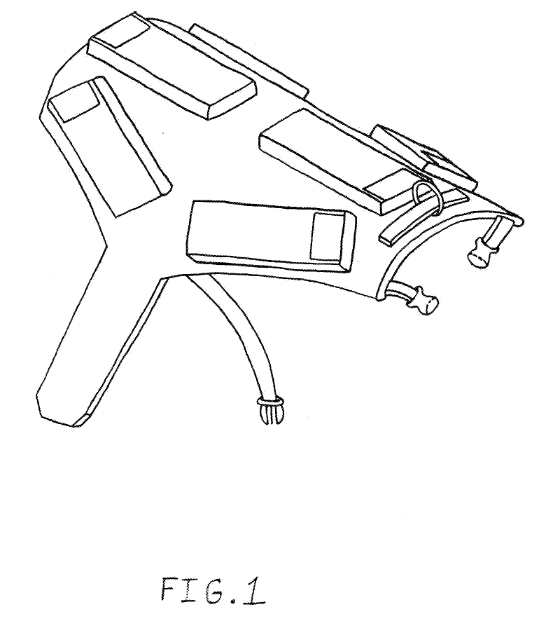

FIG. 1 is an isometric view of a WEIGHTED ANIMAL VEST showing my new product;

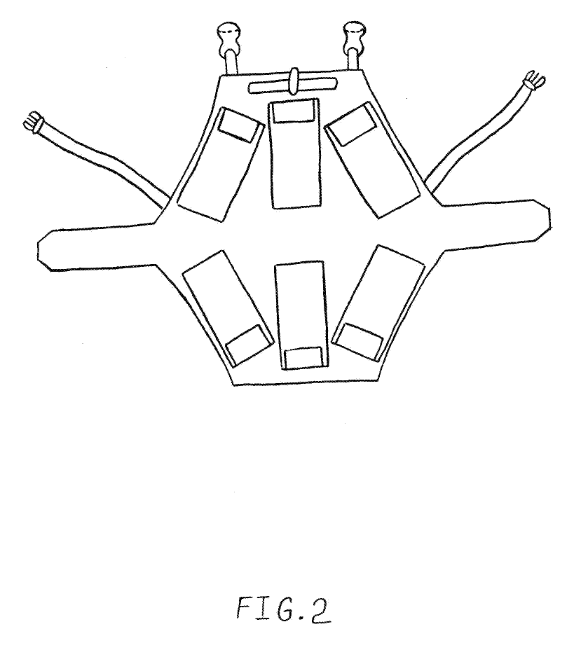

FIG. 2 is a top view thereof;

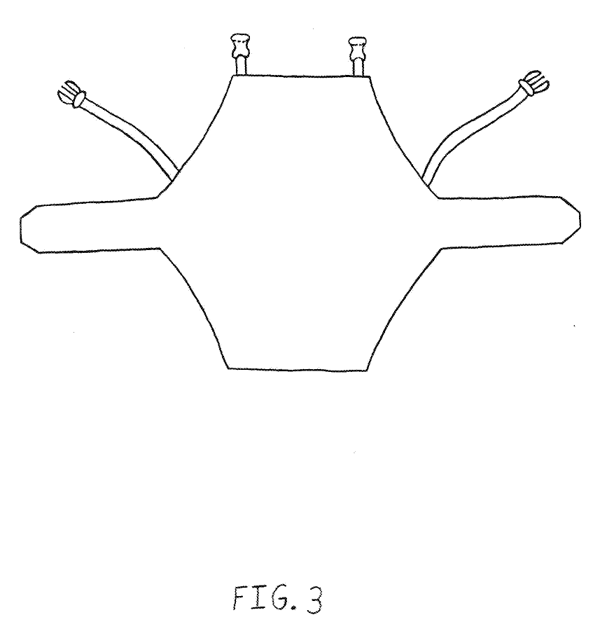

FIG. 3 is a bottom view thereof;

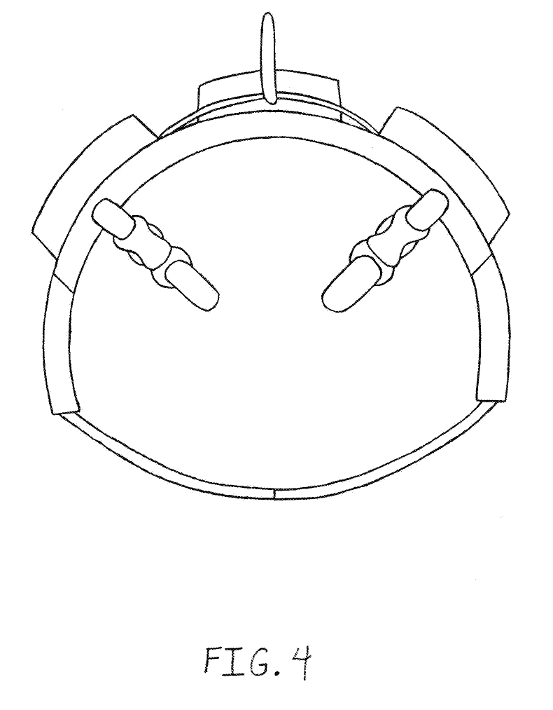

FIG. 4 is a front view thereof;

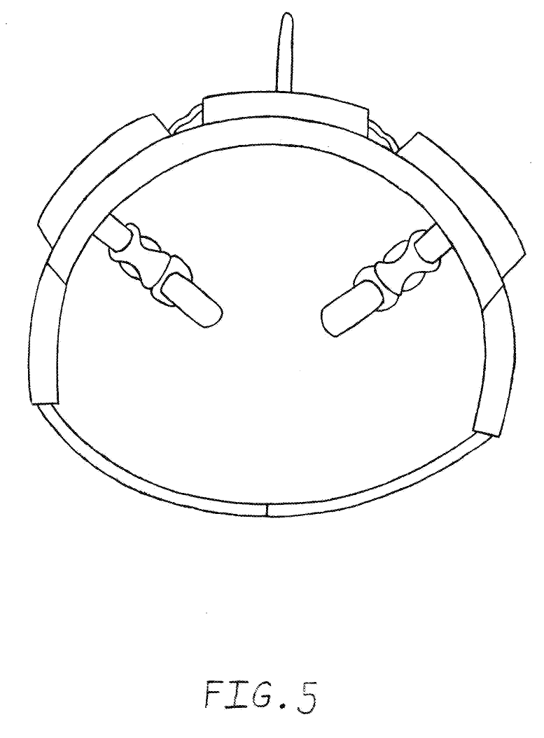

FIG. 5 is a rear view thereof;

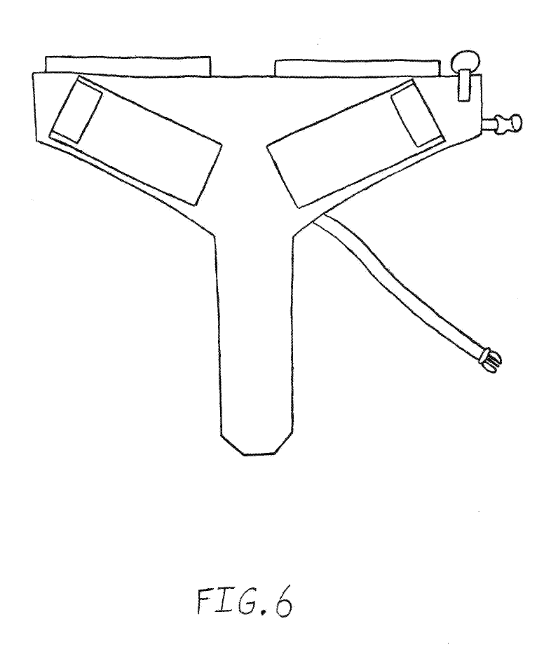

FIG. 6 is a left side view thereof;

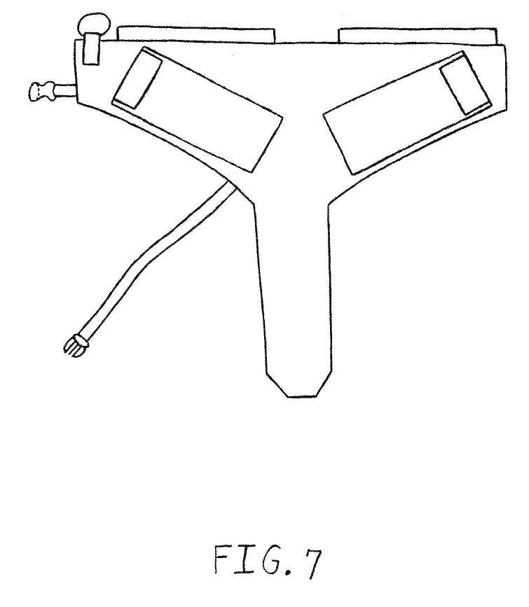

FIG. 7 is a right side view thereof;

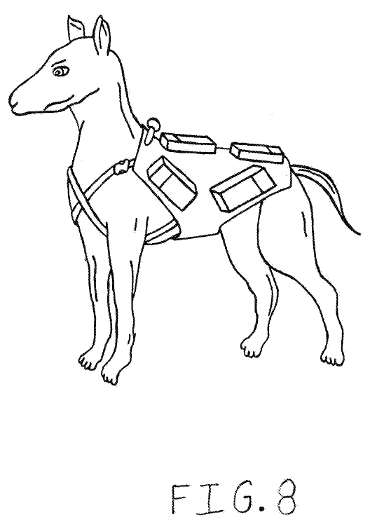

FIG. 8 is an isometric view of a dog wearing WEIGHTED ANIMAL VEST thereof;

1. Weighted Animal Vest helps build strength, endurance, muscle mass, speed and balance during daily walking and normal activity around the house.

2. Weighted Animal vest calms down high-energy or aggressive dogs because over-active dogs are easier to tire when wearing a weighted vest and less likely to exhibit destructive aggressive behavior.

3. Weighted Animal Vest helps with rehabilitating any 4 legged animal that needs strengthening because of injury or accident, strengthens weak muscles back to normal activity.

4. Weighted Animal Vest helps to prevent animal/pet obesity promotes a healthy lifestyle.

5. Weighted Animal Vest pockets are designed for balance and weights do not touch the body of your pet.

6. Weighted Animal Vest is very easy to control your dog when going on neighborhood walks and if you decide to put your dog on a treadmill it works just as well.

7. Weighted Animal Vest is padded with ½ inch soft material for comfort feels and fits snug to the body.
